(19) United States
(12) Patent Application Publication
(10) Pub. No.: US 2026/0080495 A1
(43) Pub. Date: Mar. 19, 2026

(54) CHARGING INFRASTRUCTURE WITH DEPLOYMENT AND SCHEDULING OPTIMIZATION FOR ALL-ELECTRIC EQUIPMENT RENTALS

(71) Applicant: MOXION POWER CO., Mill Valley, CA (US)

(72) Inventors: Alexander J. Smith, Mill Valley, CA (US); Paul M. Huelskamp, Mill Valley, CA (US); Alexander M. Meek, Mill Valley, CA (US); Jared T. Mickle, Mill Valley, CA (US); Sara Prochasson, Mill Valley, CA (US); Andrew Noonan, Mill Valley, CA (US)

(21) Appl. No.: 19/329,516

(22) Filed: Sep. 15, 2025

Related U.S. Application Data
(63) Continuation of application No. PCT/US2024/020270, filed on Mar. 15, 2024.
(60) Provisional application No. 63/490,392, filed on Mar. 15, 2023.

(51) Int. Cl. G06Q 50/40; B60L 53/62; B60L 53/63; B60L 53/64; B60L 53/68; G06Q 50/06

(52) U.S. Cl. CPC G06Q 50/40; B60L 53/62; B60L 53/63; B60L 53/64; B60L 53/68; G06Q 50/06; B60L 2240/662

(57) ABSTRACT

A fleet of all-electric, battery powered industrial or commercial mobile power units (MPUs) or equipment is provided. Systems and methods for managing the fleet of equipment is also provided. Observable data, such as i) equipment performance and health data, ii) electricity cost data, iii) telematic data, and iv) scheduling data, can be used by machine learning models to optimize fleet management and decision making. The machine learning model can be configured to generate suggested actions, commands, or decisions which are transmitted to fleet managers who are responsible for activities such as i) equipment charging and maintenance, ii) equipment delivery logistics, and iii) rental pricing strategy. Feedback data from the outcome of these decisions, or the completion of the related activities, can tracked and used to update the machine learning model. Interactive portals may also be utilized by customers to make reservations and managers to manage reservations, monitor the fleet of equipment and provide support to MPUs across the product lifecycle.

### INCORPORATION BY REFERENCE

This application is a continuation of PCT/US2024/020270 filed Mar. 15, 2024; which claims priority to U.S. Provisional Patent Application No. 63/490,392 , titled “CHARGING INFRASTRUCTURE WITH DEPLOYMENT AND SCHEDULING OPTIMIZATION FOR ALL-ELECTRIC EQUIPMENT RENTALS,” and filed on Mar. 15, 2023, which is incorporated by reference herein.

### FIELD

The present disclosure relates to systems and methods for operating an electric equipment rental business, which may include computer systems that implement machine-learning and/or computer-generated algorithms to optimize decision making. The electric equipment fleets may comprise mobile electric power units, electric aerial construction equipment, electric earth moving equipment, electric pick-up trucks, and other similar electric equipment.

### BACKGROUND

Equipment rental companies make decisions based on observable data, such as equipment availability, rental schedules, maintenance schedules, engine performance data, vehicle telematics, and other data. This data is needed, for example, to plan delivery logistics, to establish pricing schedules, and to plan routine maintenance, along with managing many other essential business operations. Equipment rental companies that rent equipment powered by combustion engines usually do not sell the liquid fuel or provide refueling services, which means they typically do not have to account for fuel prices or refueling logistics in their decision making.

As all-electric equipment such as electric cars, electric mobile power units, etc., continues to be a viable alternative to their combustion engine counterparts, an equipment rental company that specializes in renting electric equipment will need to make decisions that are in part based on the state of charge of the equipment to be rented. In order to rent electric equipment efficiently and profitably, equipment rental companies will need to offer new services, such as equipment charging and swapping. The dynamic nature of these data points and the importance of these services result in more complicated decision-making.

### SUMMARY OF THE DISCLOSURE

A method of training a machine learning model provide an output relating to the management of a fleet of all-electric equipment is provided, the method comprising the steps of: receiving, in a computing device, fleet information from one or more all-electric mobile power units (MPUs) of an all-electric fleet; receiving, in the computing device, charging infrastructure information from one or more charging locations or first computing systems associated with the one or more charging locations; receiving, in the computing device, electric grid information from one or more utility providers or second computing systems associated with the one or more utility providers; receiving, in the computing device, rental scheduling information including a customer request for rental of one or more all-electric mobile power units of the all-electric fleet; and applying the fleet information, charging infrastructure information, electric grid information, and/or rental scheduling information to train a machine learning model of the computing device to determine if and how the customer request for a new equipment rental can be accommodated.

In some aspects, the applying step further comprises training the machine learning model of the computing device to determine if and how a request for new equipment rental can be accommodated profitably.

In some aspects, the fleet information is selected from the group consisting of battery state of charge of individual equipment, time to empty, physical location, total energy capacity, operating temperature, and ambient temperature.

In one aspect, the fleet information is sensed or monitored directly by each MPU in the all-electric fleet and transmitted or communicated directly by each MPU to the computing device.

In other aspects, the charging infrastructure information is selected from the group consisting of availability of electric charging stations, type of charging stations, distance between individual equipment and charging station, and estimated time to charge equipment to desired charge level.

In some aspects, the electric grid information is selected from the group consisting of electricity rates that may be determined based on time-of-day, supply or demand signals, and other factors that are determined by the utility.

In additional aspects, the rental scheduling information is selected from the group consisting of requests for specific types of equipment, rental duration, number of units, or model of units to be rented, and expected energy demand.

A method of providing an output relating to the management of a fleet of all-electric equipment is provided, the method comprising the steps of receiving, in a computing device, fleet information from one or more all-electric mobile power units (MPUs) of an all-electric fleet; receiving, in the computing device, charging infrastructure information from one or more charging locations or first computing systems associated with the one or more charging locations; receiving, in the computing device, electric grid information from one or more utility providers or second computing systems associated with the one or more utility providers; receiving, in the computing device, rental scheduling information including a customer request for rental of one or more all-electric mobile power units of the all-electric fleet; and applying the fleet information, charging infrastructure information, electric grid information, and/or rental scheduling information to a trained machine learning model of the computing device; and outputting from the trained machine learning model instructions how the customer request for a new equipment rental can be accommodated.

In some aspects, outputting further comprises outputting from the trained machine learning model instructions how the customer request for a new equipment rental can be accommodated profitably.

In other aspects, the fleet information is selected from the group consisting of battery state of charge of individual equipment, time to empty, physical location, total energy capacity, operating temperature, and ambient temperature.

In one aspect, the fleet information is sensed or monitored directly by each MPU in the all-electric fleet and transmitted or communicated directly by each MPU to the computing device.

In some aspects, the charging infrastructure information is selected from the group consisting of availability of electric charging stations, type of charging stations, distance between individual equipment and charging station, and estimated time to charge equipment to desired charge level.

In some aspects, the electric grid information is selected from the group consisting of electricity rates that may be determined based on time-of-day, supply or demand signals, and other factors that are determined by the utility.

In other aspects, the rental scheduling information is selected from the group consisting of requests for specific types of equipment, rental duration, number of units, or model of units to be rented, and expected energy demand.

A system is provided, comprising one or more all-electric mobile power units (MPUs) having sensors configured to monitor one or more parameters of the MPUs; an electric distribution grid configured to provide electricity at one or more prices per unit of electricity according to a pricing schedule; a charging infrastructure comprising one or more physical locations electrically coupled to the electric distribution grid, each physical location having one or more charging stations or charging units configured to charge MPUs and charging infrastructure information related to the one or more charging stations or charging units; a web or cloud-based scheduling engine configured to receive rental requests from one or more customers for one or more MPUs; and a central processing server configured to determine if the rental requests can be accommodated profitably based on one or more received parameters of the MPUs, a received pricing schedule from the electric distribution grid, a received a status of the one or more charging stations or charging units from the charging infrastructure, and based on received rental requests from the web or cloud-based scheduling engine, the central processing server being further configured to output instructions relating to the one or more customer requests.

In some aspects, the one or more parameters of the MPUs corresponds to MPU information displayed on a user interface on an interface panel located on the one or more of the MPUs.

In other aspects, the one or more parameters of the MPUs is selected from the group consisting of battery state of charge, time to empty, physical location, total energy capacity, operating temperature, and ambient temperature.

In one aspect, the charging infrastructure information is selected from the group consisting of availability of electric charging stations, type of charging stations, distance between individual equipment and charging station, and estimated time to charge equipment to desired charge level.

In some aspects, the pricing schedule is selected from the group consisting of electricity rates that may be determined based on time-of-day, supply or demand signals, and other factors that are determined by the utility.

In some aspects, the customer request can include scheduling information selected from the group consisting of requests for specific types of equipment, rental duration, number of units, or model of units to be rented, and expected energy demand.

In additional aspects, the central processing server is further configured to remotely execute one or more of: (i) determining a rental price for the one or more customer requests, (ii) modifying a rental price for the one or more customer requests, (iii) outputting instructions requesting dispatch of one or more MPUs to one or more customer locations, (iv) outputting instructions requesting collection of one or more MPUs from one or more customer locations, (v) outputting instructions to replace one or more MPUs when a low state of charge is predicted or determined, and (vi) outputting instructions to send one or more MPUs for charging at physical location of the charging infrastructure.

In one aspect, the central processing server implements one or more automated agents configured to provide inputs to a trained machine learning model to determine if the rental requests can be accommodated profitably.

In some aspects, a method for maximizing profitability of rental operations for an all-electric equipment fleet is provided, comprising: receiving, in a computing system, a plurality of inputs including one or more of data from: (i) one or more mobile power units (MPUs), (ii) charging infrastructure, (iii) delivery vehicles, (iv) already deployed MPUs, (v) customer requests for rental of one or more MPUs; determining, in the computing system, a schedule for optimized charging of one or more MPUs and delivery logistics for the one or more MPUs to one or more locations; and outputting, from the computing system, the schedule for optimized charging and delivery logistics.

In one aspect, the method includes modifying the customer request if the determined schedule cannot accommodate the customer request profitably.

In some aspects, the method further includes outputting the modified customer request to the customer and/or to computing systems associated with the charging infrastructure and delivery vehicles.

In some aspects, the customer request is not modified if it is determined in the computing system that the schedule is not modifiable to maximize profit.

In another aspect, the method includes outputting the schedule to the customers and/or to computing systems associated with the charging infrastructure and delivery vehicles.

A method for determining rental equipment availability and price of a mobile power unit (MPU) for a customer is provided, comprising: receiving, in a computing system, a customer request for rental equipment; determining, in the computing system, availability of the rental equipment; offering, in the computing system, a price to the customer; determining, in the computing system, a charge status of the rental equipment; and outputting, from the computing system, instructions to deliver the rental equipment to the customer.

In some aspects, determining availability of the rental equipment includes one or more of: determining whether the rental equipment is available for pickup from another customer, determining whether the equipment may be delivered from another rental location, determining whether the customer has flexibility to receive the rental equipment on another date, and determining the suitability of alternative rental equipment.

In another aspect, the offered price to the customer is modified based on determining availability of the rental equipment.

In some aspects, the method includes determining that the rental equipment is not charged, wherein a least expensive charging queue is selected from among a plurality of charging queues to charge the equipment for timely delivery to the customer.

In other aspects, the least expensive charging queue is modified to accommodate the customer.

In some aspects, a more expensive charging queue is selected from among the plurality of charging queues to charge the equipment.

In some aspects, the price offered to the customer is modified based on one or more of: (i) modifying the least expensive charging queue, and (ii) selecting the more expensive charging queue.

In another aspect, the method includes: receiving one or more requests for rental equipment from one or more new customers at one or more of the plurality of charging queues; determining whether the plurality of charging queues can accommodate the one or more requests for rental equipment; determining whether a least expensive of the plurality of charging queues needs to be modified to accommodate the one or more requests for rental equipment; and charging the equipment using one or more of the plurality of charging queues.

In one aspect, a system is provided comprising: one or more processors; memory coupled to the one or more processors, the memory configured to store computer-program instructions, that, when executed by the one or more processors, implement a computer-implemented method, the computer-implemented method comprising: receiving fleet information from one or more all-electric mobile power units (MPUs) of an all-electric fleet; receiving charging infrastructure information from one or more charging locations or first computing systems associated with the one or more charging locations; receiving electric grid information from one or more utility providers or second computing systems associated with the one or more utility providers; receiving rental scheduling information including a customer request for rental of one or more all-electric mobile power units of the all-electric fleet; and applying the fleet information, charging infrastructure information, electric grid information, and/or rental scheduling information to train a machine learning model of the computing device to determine if and how the customer request for a new equipment rental can be accommodated.

A system is also provided comprising: one or more processors; memory coupled to the one or more processors, the memory configured to store computer-program instructions, that, when executed by the one or more processors, implement a computer-implemented method, the computer-implemented method comprising: receiving fleet information from one or more all-electric mobile power units (MPUs) of an all-electric fleet; receiving charging infrastructure information from one or more charging locations or first computing systems associated with the one or more charging locations; receiving electric grid information from one or more utility providers or second computing systems associated with the one or more utility providers; receiving rental scheduling information including a customer request for rental of one or more all-electric mobile power units of the all-electric fleet; and applying the fleet information, charging infrastructure information, electric grid information, and/or rental scheduling information to a trained machine learning model of the computing device; and outputting from the trained machine learning model instructions how the customer request for a new equipment rental can be accommodated.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1A is a diagram showing an example of a computing environment configured to optimize, schedule, and deploy an all-electric rental equipment fleet.

FIG. 1B is a diagram showing an example of information engine(s).

FIG. 1C is a diagram showing an example of machine learning engine(s).

FIG. 2 is a schematic diagram illustrating the various components and electrical connections within a battery powered mobile power unit.

FIG. 3 is an illustration of an all-electric equipment fleet at various points during rental operations in a geographic area (a city, town, state, etc.).

FIG. 4A is one example of a method for training a machine learning model to make decisions relating to the management, charging, scheduling, and optimization of a fleet of all-electric equipment.

FIG. 4B is one example of a method of using a trained machine learning model to provide an output relating to the management, charging, scheduling, rental pricing, and optimization of a fleet of all-electric equipment.

FIG. 5 is an example flowchart with one method for optimizing charging and rental logistics and scheduling.

FIG. 6 is a logic flowchart for a new customer request for rental equipment.

FIG. 7 illustrates a visual reservation summary of a fleet of active mobile power units.

FIG. 8 illustrates a schedule view diagram of mobile power units.

FIG. 9 illustrates an exemplary view of mobile power unit (MPU) information.

FIG. 10 illustrates a reservation management view for various customer reservations.

FIG. 11 illustrates a reservation creation interface for mobile power units.

FIG. 12 illustrates a method for requesting a reservation at a rental customer portal.

FIG. 13 illustrates a method for fleet management at a fleet management portal.

### DETAILED DESCRIPTION

The present disclosure describes systems and methods for managing a fleet of all-electric rental equipment. The all-electric fleet of equipment can include, for example, battery-powered industrial or commercial grade mobile power units (MPUs) configured to supply a variety of user-selected power outputs, including 480 VAC 3-phase outputs, 208 VAC 3-phase outputs, and 240 VAC single-phase outputs from a DC electrical energy source. In some embodiments, the rental equipment can further include electric vehicles, electric construction equipment, etc. The battery-powered mobile power units of the present disclosure are configured to be transported to a temporary power site to provide multiple power output options depending on the specific need.

Described herein are apparatuses (e.g., systems, computing device readable media, devices, etc.) and methods for training a machine learning model to manage a fleet of all-electric rental equipment, including charging, optimization, scheduling, and fleet management/deployment. One object of the present disclosure is to use machine learning technology to provide an automatic rental deployment system that can manage and optimize commercial sales, rentals, charging, and deployment of the fleet. The machine learning model can make this determination based upon data including fleet information from the MPUs (e.g., battery state of charge of individual equipment, time to empty, physical location, fleet health and availability), 3^{rd} party information (e.g., including availability of delivery drivers and/or delivery trucks, distance/route information between available equipment and customer delivery address, etc.), charging infrastructure information (e.g., availability of electric charging stations, type of charging stations, distance between individual equipment and charging station, estimated time to charge equipment to desired charge level, etc.), electric grid information (e.g., rates that may be determined based on time-of-use, demand charge management, spot market prices, supply or demand signals, and other factors that are determined by the utility), rental scheduling information (e.g., demand/reservations from customers for specific types of equipment or applications) and other parameters such as traffic and weather forecasts. These methods and apparatuses can use this information to train a machine learning model and use the machine learning model to make optimized decisions related to customer selection, pricing, rental scheduling and logistics, transportation and swaps, repairs and maintenance, general management, charging, and other important business decisions.

For example, described herein are apparatuses and/or methods, e.g., systems, including systems to automatically implement processes that incorporate a rental deployment system. When the system is triggered by a request for rental deployment, the system can retrieve fleet information, electric grid information, delivery information, and rental scheduling information from a local or remote database. This information can be passed into the machine learning model, which may use machine learning technology (e.g., U-Net, Convolutional Neural Network (CNN), Decision Tree, Random Forest, Logistic Regression, Support Vector Machine, AdaBOOST, K-Nearest Neighbor (KNN), Quadratic Discriminant Analysis, Neural Network, etc.) to identify available equipment including state of charge and location, identify available charging infrastructure if needed to recharge the identified equipment, and provide an output (e.g., on a display) with rental logistics and how to meet the customer demand for rental deployment. The parameters inputted into the machine learning model can be optimized with historic data. The results may be provided on demand and/or may be stored in a memory (e.g., database) for later use.

According to one embodiment, a system is provided, including: one or more mobile power units having sensors to monitor parameters of the MPU, including but not limited to a state of charge, time to empty, total energy capacity, operating and/or ambient temperature, GPS location, etc. in real-time, and provide the measured or sensed parameters to a central processing server or processor (e.g., a cloud server), the system further including a charging infrastructure, electric grid, a scheduling information engine, and the central processing server, wherein the central processing server determines management of unit operations based on inputs received from the one or more mobile power units, charging infrastructure, electric grid, and scheduling information engine.

According to one embodiment of the system, the real-time monitored parameters can be presented to a user interface on an interface panel located on the one or more mobile power units and/or on one or more displays accessing a cloud web application of the central processing server.

According to one embodiment of the system, the parameters for unit operations include: delivery times, locations, distances between mobile power units and delivery sites, charge thresholds, rental price, rental duration, available and reserved mobile power units, battery usage and usage requirements, and availability and capacity of charging infrastructure.

According to one embodiment of the system, the central processing server is configured to remotely execute one or more of: (i) determining a rental price, (ii) modifying a rental price, (iii) sending instructions for dispatch of the one or more mobile power units to customer locations, (iv) sending instructions for collection of the one or more mobile power units from customer locations, (v) swapping one or more of the mobile power unites when a low state of charge is predicted, and (vi) sending the one or more mobile power units for charging at a charging site, based on one or more of the parameters for unit operations, inputs received from the one or more mobile power units and requests for customer rentals received at the scheduling information engine.

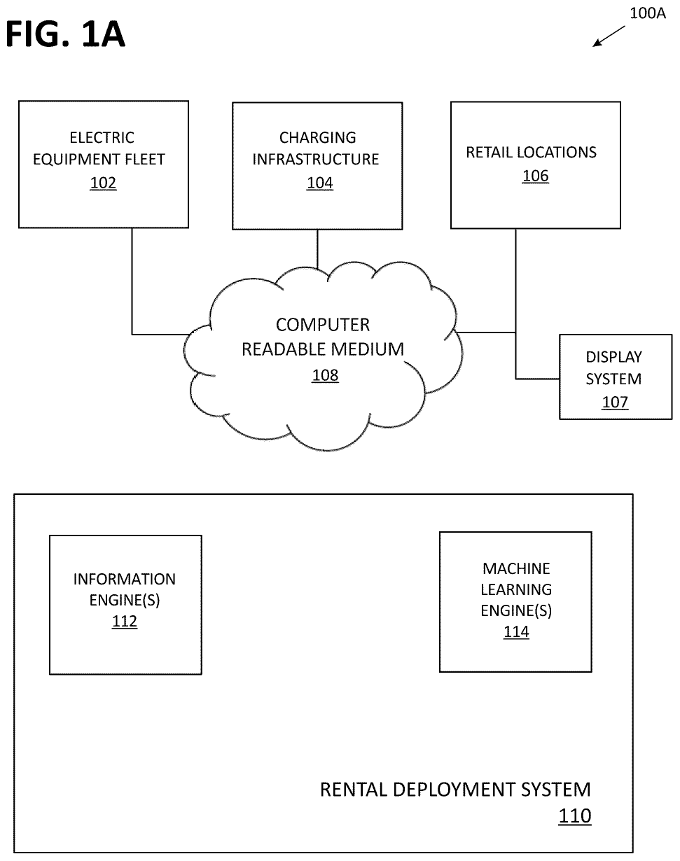

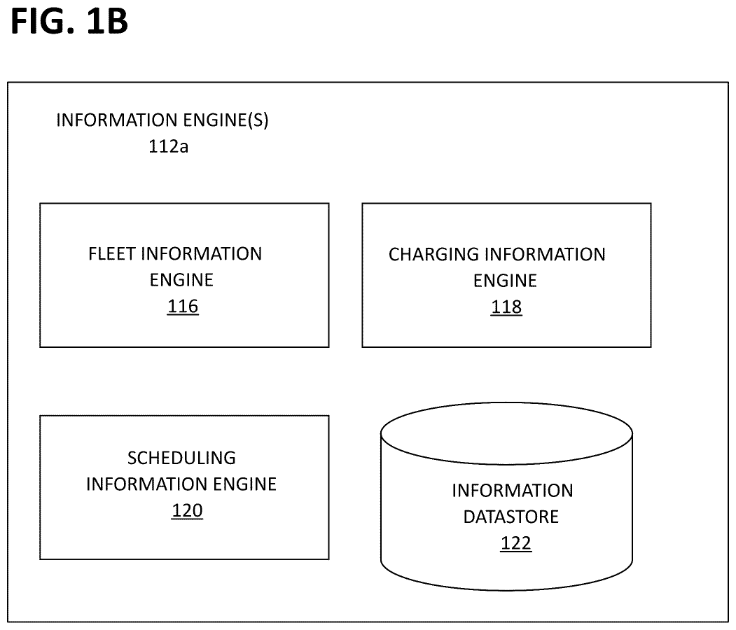

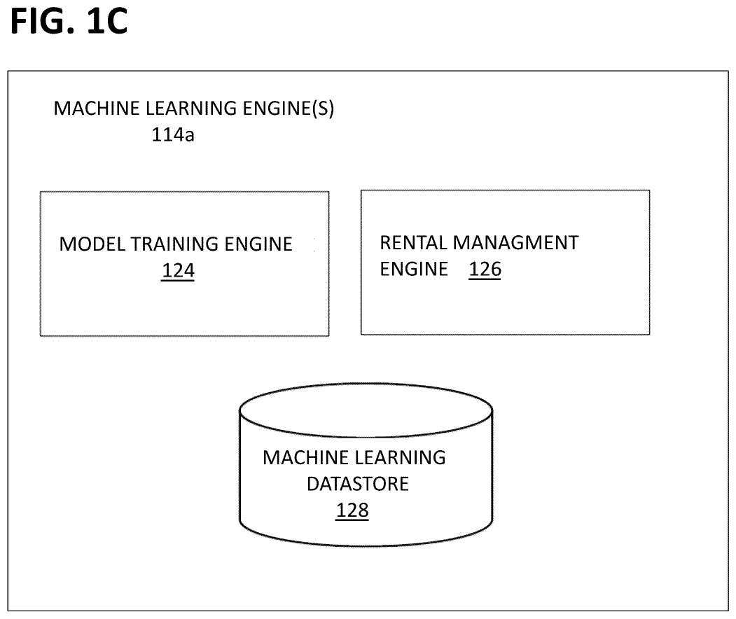

FIG. 1A is a diagram showing an example of a computing environment 100A configured to manage a fleet of all-electric rental equipment. According to certain embodiments, the fleet of all-electric rental equipment may be a fleet of mobile power units (MPUs). According to other embodiments, the fleet can be any combination of electric/battery powered equipment including MPUs, electric vehicles, electric construction equipment, other equipment to be charged, etc. The environment 100A includes an electric equipment fleet 102, a charging infrastructure 104, retail locations 106, a display system 107, a computer readable medium 108, and a rental deployment system 110. According to certain embodiments, display system 107 may be embedded on one or more of the MPUs and a cloud-based web application, and the displays may correspond to each other. One or more of the modules in the computing environment 100A may be coupled to one another or to modules not explicitly shown.

The computer-readable medium 108 and other computer-readable media discussed herein are intended to represent a variety of potentially applicable technologies. For example, the computer-readable medium 108 can be used to form a network or part of a network. Where two components are co-located on a device, the computer-readable medium 108 can include a bus or other data conduit or plane. Where a first component is co-located on one device and a second component is located on a different device, the computer-readable medium 108 can include a wireless or wired back-end network or LAN. The computer-readable medium 108 can also encompass a relevant portion of a WAN or other network, if applicable.

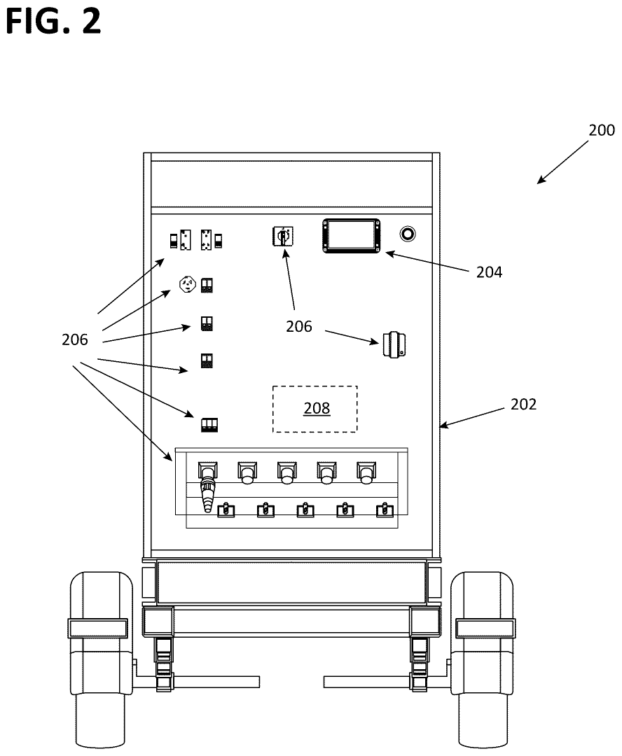

The electric equipment fleet 102 can include all-electric equipment such as electric cars, electric mobile power units, electric construction equipment, etc. The fleet of electric equipment may include any number of electric machines or equipment, as well as existing equipment that is not electric, as the transition to all-electric equipment will not happen at once, but over time. In some embodiments, the electric equipment fleet can include a plurality of all-electric mobile power units, such as the mobile power unit (MPU) of FIG. 2. The electric equipment fleet are individually powered by all-electric energy storage such as batteries, and not by internal combustion engines. As such, the electric equipment fleet requires additional intervention and/or management from the fleet rental company to manage energy levels and recharging of the fleet. As such, each piece of the all-electric fleet can include one or more sensors and/or monitoring electronics along with communications electronics to monitor, sense, and transmit information relating to the health and operation of the equipment, including charge level, battery health, state of charge, time to empty, location, rate of discharge/use, etc. This information can be communicated to, for example, the computer-readable medium 108, other pieces of equipment in the all-electric fleet, and/or to the retail locations of the rental company.

FIG. 2 shows one embodiment of an all-electric mobile power unit 200, including a view of an interface panel 202. The interface panel 202 can include, for example, a user interface 204 such as a Graphical User Interface (GUI), and a plurality of electrical connectors 206. The user interface is configured to provide an input and/or a display for a user to configure the mobile power unit into the desired operating mode, including selecting the desired electrical output and/or enabling/disabling one or more of the electrical connectors. In some embodiments, in addition to being integrated into the interface panel, the user interface or GUI can be a remote device, such as a smartphone, table, or pc, which can be configured to communicate with and configure the mobile power unit via wireless technologies such as Bluetooth, WiFi, cellular, etc. System parameters and configurations can also be displayed to the user on the remote device. As the mobile power unit is often used outdoors, the mobile power unit can include a housing configured and designed to be exposed to the elements and general road conditions experienced by heavy duty trucks and buses, and is therefore designed to be resistant to shock/vibration/salt spray etc.

The mobile power unit 200 can include an electrical energy source disposed within the outer housing. In one configuration, the electrical energy source comprises a plurality of lithium-ion battery cell groups arranged in series connections. In other embodiments, the electrical energy source can comprise other known energy storage devices, such as ultracapacitors or fuel cells. While lithium-ion is presently the preferred battery cell type, it should be understood that other battery cells can be used in place of lithium-ion cells as battery technology evolves. One specific example utilizes 5 Ah, 18 Wh Lithium-manganese-cobalt-oxide batteries (NMC) or nickel-cobalt-aluminum oxide (NCA) cells commonly available in a 21700 cell format. In this example, the cell groups can be arranged in groups of 320 cells in 108 series connections for approximately 620 kWh of total energy storage. In some examples, the electrical energy source can have an operating voltage range of 300-800V.

Varying types of electrical connectors can be provided on the interface panel depending on the output and connection needs of the particular site. For example, the illustrated interface panel includes one or more North American Non-Locking receptacles, one or more CS6365 receptacles, one or more SAE J1772 connectors, one or more taper nose cam lock connectors, and/or one or more threaded fastener style connectors. The mobile power unit can be further configured to provide three-phase power outputs including line ends, active neutral line(s), and a ground connection. It should be understood that in other embodiments, other types of electrical connectors can be utilized on the interface panel.

The all-electric mobile power unit of FIG. 2 can further include various electronic components 208, typically disposed within the housing of the unit. However, in some embodiments some or all of these electrical components can be integrated into other components of the mobile power unit, or alternatively can be disposed within external devices or external controllers. These electronic components can include, for example, electronic controllers, microcontrollers, charge and battery management controllers, power distribution unit(s), sensors, and communications systems including wireless and wired communications (Bluetooth, WiFi, cellular, satellite, etc.). These electronic controllers and sensors can provide, measure, and/or store information and/or parameters relating to the operation of the mobile power unit, including state of charge, battery health, time to empty, energy usage, time required to charge the battery cells to 25/50/75/100%, current power draw, capacity levels available for each phase line and/or output mode, etc.) The electronic components can further include one or more sensors configured to measure parameters relating to the operation and/or safety of the mobile power unit (e.g., temperature sensors, GPS sensors, etc.). For example, the sensors can include temperature sensors configured to sense a temperature of various components of the unit such as battery temperature, external temperature, interior temperature, etc. The measured and sensed parameters described above can be wirelessly communicated from the mobile power unit to a remote computer or server, such as the computer readable medium 108 of FIG. 1A.

Referring back to FIG. 1A, charging infrastructure 104 can include one or more electric vehicle charging stations or electronic charging stations (ECS) configured to supply electric energy for recharging of the all-electric equipment fleet. According to certain embodiments, the MPUs may be recharged with diesel generators. In some embodiments, the charging infrastructure can include individual charging stations spaced out across a geographic area, and in other embodiments the charging infrastructure can include facilities with a plurality of electronic charging stations. The charging infrastructure can include AC or DC slow chargers (e.g., approximately 3kW-6 kW), AC or DC fast chargers (e.g., approximately 7 kW-25 kW), AC or DC rapid chargers (e.g., 50 kW-350 kW), or superchargers. Additionally, these charging stations can include and/or accommodate a plurality of connectors, including UK 3-pin (BS 1363), Industrial Commando (IEC 60309), Type 1 (SAE J1772), Type 2 (Mennekes, IEC 62196), UK 3-pin (BS 1363), CHAdeMO (Japanese JEVS), CCS (Combined Charging System or ‘Combo’), Tesla's proprietary supercharger connectors, etc.

The charging infrastructure can include its own computer systems and or cloud or remote servers that are configured to communicate bi-directionally with a central server or computer (e.g., computer-readable medium 108) with information pertaining to the function and use of the individual charging stations (e.g., whether a charging station is functional/nonfunctional or in use/already charging an EV or piece of electric equipment). Additionally, the charging infrastructure can obtain, store, and/or communicate information relating to the electric grid upon which each of the individual charging stations reside, including electricity pricing/rates based on time-of-day, supply or demand signals, and other factors that are determined by the utility. In some embodiments, electric grid information or additional information relating to the electric grid can come from another source, such as from another cloud server or directly from one or more utility providers. Alternatively, the grid information can be compiled and stored in a lookup table or database on the central server or computer (e.g., computer-readable medium 108).

Retail locations 106 can comprise one or more physical locations for storage and/or rental operations of the all-electric equipment fleet. In some aspects, the retail locations include computer or cloud servers that include information pertaining to the operation of the retail location, including inventory, location of the retail location, proximity to preferred vendors or delivery services, state of charge and other parameters of MPUs or other electric equipment on-site, availability and status of charging equipment on site, etc. These computers or cloud servers can also be configured to communicate this information bi-directionally with other computing systems or platforms described herein, including the central server or computer (e.g., computer-readable medium 108). Alternatively, this information can be transmitted and stored on the central server itself. In some embodiments, the rental locations can also include one or more electronic charging stations, so it should be understood that the charging infrastructure 104 and retail locations 106 can be intertwined or combined. However, in other embodiments, the retail locations may not have the capacity to charge the entire fleet, so some or all charging operations may be performed remotely or separate from the retail locations. According to certain embodiments, the MPUs may be charged with solar and photovoltaic (PV) technologies, in addition to traditional generators, at the retail locations or other locations. In some embodiments, the retail locations can include employees on site to handle the day-to-day operations, including coordinating rentals of all-electric equipment to customers, physically charging the all-electric fleet, and/or managing deliveries or pickups of all-electric equipment. In other embodiments, the rental locations can include only self-serve electronic kiosks and customers can pickup and drop-off electric equipment rentals without human interaction.

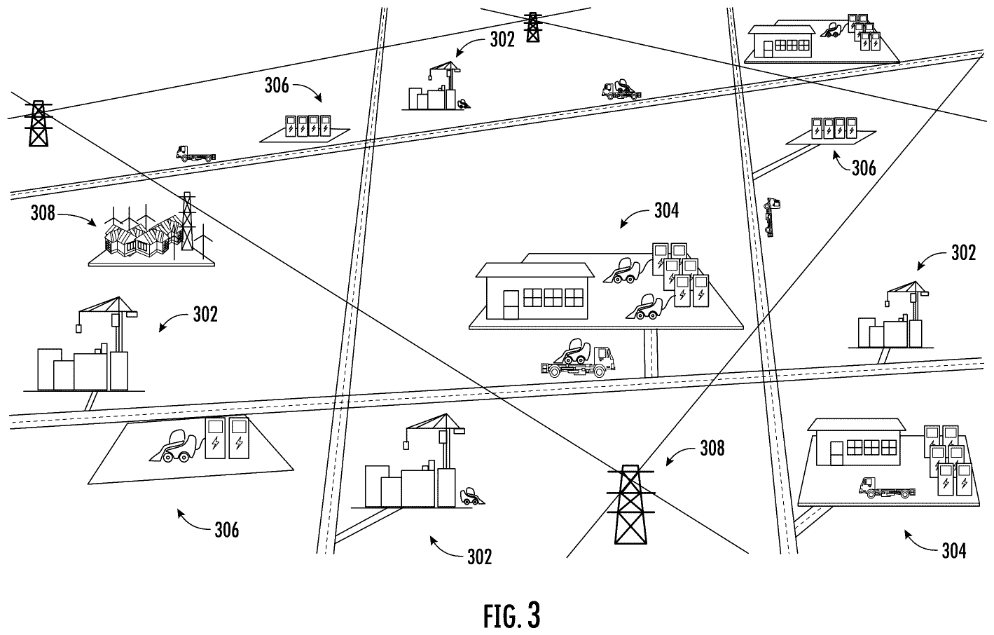

FIG. 3 is an illustration of an all-electric equipment fleet at various points during rental operations in a geographic area (a city, town, state, etc.). These operations may include the delivery of equipment to and from customer jobsites 302, and the charging of equipment at rental locations 304 and at off-site charging locations 306 (e.g., charging infrastructure).

The fleet of equipment and/or related technology may be associated with one or more rental locations, each of which may be operated by the equipment rental company, one or more franchisees, or 3^{rd} party equipment rental business that license the technology and/or software. Each rental location may have charging hardware and electrical infrastructure that supports equipment charging. The electrical infrastructure may be coupled to an electrical grid that is operated by a utility company 308, which is responsible for providing electricity to customers in the geographical area at rates that may be determined based on time-of-use, demand-charge management, spot market prices, supply or demand signals, and other factors that are determined by the utility.

The off-site charging locations may be located along various routes within the geographical area and may be owned by the rental company, its franchisees, and/or 3^{rd} party companies including private companies, non-profits, government agencies, etc. The off-site charging locations may be accessible by the rental company and may offer an alternative to simply returning to a rental location to perform equipment charging. These off-site charging stations may receive electricity from the same utility company or a different utility company, and at similar rates or different rates as what is offered to the equipment rental company or its partners, operators, and/or franchisees. There may be several pricing structures and/or payment mechanisms between the equipment rental company and the owners of the off-site charging location for the use of the off-site charging equipment, which may be different than the pricing offered to the equipment rental company at its rental location.

Referring again to FIG. 1A, the display system 107 may include a computer system configured to display parameters or information relating to the electric equipment fleet, the charging infrastructure, the retail locations, and/or rental charging, optimization, and scheduling. The display system 107 may include memory, one or more processors, and a display device to display information relating to the equipment fleet, including instructions for the management and operation of the fleet. The display system can comprise a plurality of displays in communication with or connected to a computer system or network of computer systems. In some embodiments, one or more displays of the computer system can be located in or at the retail locations, the charging infrastructure, or remotely to these physical locations (e.g., at a corporate headquarters of the rental company). In some aspects, the display system can include individual users (e.g., customers and/or managers of the fleet) accessing a web application on a personal computing device such as a pc, smartphone, or tablet. In some implementations, the display system 107 facilitates display of information relating to the operation, management, rental logistics, scheduling, and/or charging of an all-electric equipment fleet. In some embodiments, the display system 107 can provide an output with instructions on which electric equipment to charge and where to charge it so as to meet rental demands. In some aspects, the output on the display can further be linked or tied to automated instructions sent to other computing devices to initiate management of rental or sales operations, including instructions to charge one or more electric MPUs or equipment or instructions to deploy or deliver one or more electric MPUs or equipment.

The rental deployment system 110 in FIG. 1A may include a computer system, including memory and one or more processors, configured to manage a fleet of all-electric equipment rentals, including charging, optimization, scheduling, and fleet management/deployment. In one implementation, the rental deployment system 110 is configured to obtain information relating to management and optimization of the rental fleet of all-electric equipment. For example, the rental deployment system can obtain fleet information including the amount, availability, and location of each type of equipment, and battery/energy information for each piece of equipment in the fleet including state of charge, time to empty, total energy capacity, etc. The rental deployment system may be further configured to obtain information relating to the charging infrastructure, including the availability of electric charging stations (e.g., whether or not they are in use), the type of charging stations that are available (e.g., slow charger, fast charger, rapid charger, supercharger, etc.), distance between charging stations and equipment in need of charge, and estimated time to charge equipment to desired charge level, etc. The rental deployment system may be further configured to obtain information relating to the electric grid and contractual commitments with power market participants, including electricity rates that may be determined based on time-of-day, supply or demand signals, and other factors that are determined by the utility, as well as demand response programs, capacity contracts, or other commitments or contractual obligations with power market participants. Additionally, the rental deployment system may be configured to obtain scheduling/rental information relating to new/upcoming reservations for equipment rentals, rental returns, and/or current rentals/reservations for equipment that is in need of recharging or service. The rental deployment system may also be configured to communicate with or receive information from 3^{rd} party vendors such as delivery companies to assess availability of trucks or other delivery equipment for deploying one or more electric equipment to a desired rental, charging, or customer location. The rental deployment system 110 is configured to input the information described above to train a machine learning model and use the machine learning model to make decisions on rental scheduling, management, optimization, deployment, and charging of an all-electric equipment fleet. The rental deployment system 110 may include information engine(s) 112 and machine learning engine(s) 114. One or more of the modules of the rental deployment system 110 may be coupled to each other or to modules not shown.

FIG. 1B is an illustration of information engine(s) 112a of the rental deployment system 110, which may implement automated agents to retrieve and/or process information relating to the management, charging, scheduling, and optimization of a fleet of all-electric equipment. The information engine(s) 112a may include a fleet information engine 116, a charging information engine 118, a scheduling information engine 120, and an information datastore 122. One or more of the modules of the information engine(s) 112a may be coupled to each other or to modules not shown.

Fleet information engine 116 can implement automated agents configured to obtain fleet information including the amount, availability, and precise GPS location of each type of equipment or MPU, and battery/energy information for each piece of equipment in the fleet including state of charge, time till empty, total energy capacity, operating conditions, real-time capacity output, weather forecast, operating mode (hybridization, parallelization, stand-alone), etc. The fleet information can be obtained directly from individual equipment of the fleet (e.g., the information can be communicated directly from the equipment), or alternatively, the information can be obtained from a local or remote database.

Charging information engine 118 can implement automated agents configured to obtain charging information including the availability of electric charging stations, the type of charging stations that are available (e.g., slow charger, fast charger, rapid charger, supercharger, etc.), the distance between charging stations and equipment in need of charge, and estimated time to charge equipment to desired charge level, etc. According to certain embodiments, determining when to charge may be determined by these aforementioned factors, as well as: state of charge, time to empty (TTE), real time power output (how quickly the MPU is being discharged), etc. The charging information engine 118 may be further configured to obtain charging information relating to the electric grid, including electricity rates that may be determined based on time-of-day, supply or demand signals, and other factors that are determined by the utility, as well as demand response contracts, capacity contracts, or other commitments or contractual obligations with power market participants. The charging information can be obtained directly from individual electric charging stations, from the electric grid itself, or from local or remote databases.

Scheduling information engine 120 may implement automated agents configured to obtain scheduling/rental information relating to new/upcoming reservations for equipment rentals, rental returns, and/or current rentals/reservations for equipment that is in need of swapping, recharging or service. The scheduling/rental information may include, but not be limited to, number of pending rental requests, including the length of the rental requests and the number of units desired, the number of available MPUs, and the state of charge of each MPU, the location of available MPUs, the proximity of available MPUs to each rental request, the availability of shipping providers to deliver non-local MPUs to a rental customer in the absence of available local MPUs, the location of the rental requests (where MPUs should be delivered), the target usage of the MPUs (what equipment they are going to power), weather forecasts, traffic conditions, etc.

The information datastore 122 may be configured to store data related to the management, charging, optimization, and scheduling of the electric fleet, including the information described above.

FIG. 1C is an illustration of machine learning engine(s) 114a of the rental deployment system 110, which may implement automated agents to retrieve information from the information engine(s) 112a, train a machine learning model to process information relating to the management, charging, scheduling, and optimization of a fleet of all-electric equipment, and/or use a trained machine learning model to process information relating to the management, charging, scheduling, rental pricing, and optimization of a fleet of all-electric equipment. The machine learning engine(s) 114a may include a model training engine 124, a rental management engine 126, and a machine learning datastore 128. One or more of the modules of the machine learning engine(s) 114a may be coupled to each other or to modules not shown.

The model training engine 124 may implement one or more automated agents configured to use machine learning techniques to train a machine learning model to process information relating to the management, charging, scheduling, rental pricing, and optimization of a fleet of all-electric equipment. Multiple training cases can be used to train the model. In some implementations, the model training engine 124 is configured to use these inputs to train a convolutional network to make decisions regarding all-electric fleet management.

Examples of machine learning systems that may be used by the model training engine include, but are not limited to, Convolutional Neural Networks (CNN) such as U-Net, ResNeXt, Xception, RefineNet, Kd-Net, SO Net, Point Net, or Point CNN, and additional machine learning systems such as Decision Tree, Random Forest, Logistic Regression, Support Vector Machine, AdaBoosT, K-Nearest Neighbor (KNN), Quadratic Discriminant Analysis, Neural Network, etc. Additionally, the variations of the CNNs described above can be implanted. For example, a CNN such as Unet can be modified to use alternative convolutional blocks (e.g., ResNeXt or Xception) instead of the VGG-style blocks that are implemented by default.

The rental management engine 126 may implement one or more automated agents configured to use the trained machine learning model to automatically make decisions or provide an output relating to the management, charging, scheduling, rental pricing, and optimization of a fleet of all-electric equipment. For example, if a request for an equipment rental is made, the trained machine learning model can be configured to identify available equipment, determine if the available equipment can be delivered to the customer prior to the rental request start date, determine if the state of charge of the identified equipment is sufficient, and if not, can be configured to determine a charging location and the optimal time/duration to charge the equipment and coordinate delivery logistics to ensure that the rental can be accommodated profitably. The trained machine learning model can be further configured to determine where and when equipment in the fleet should be stored (e.g., which retail or charging location) and when equipment needs to be serviced or picked up from a customer. The trained machine learning model can be further configured to manage the state of charge of individual equipment in a fleet even when a request for an equipment rental is not made, to prepare the rental company for future/anticipated demand, future/anticipated utility price signals, etc., and ensure that the fleet is charged to the appropriate level.

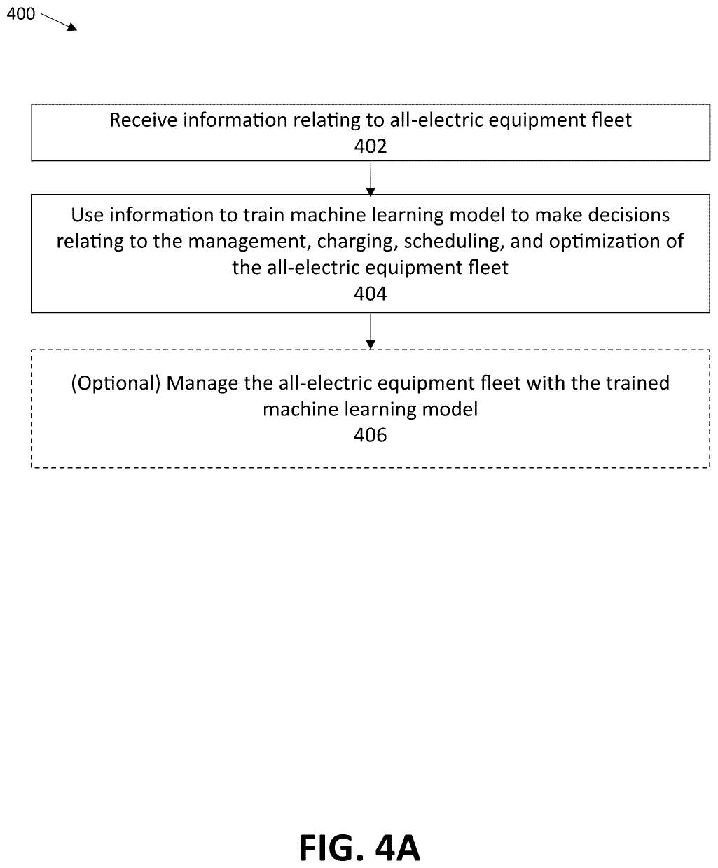

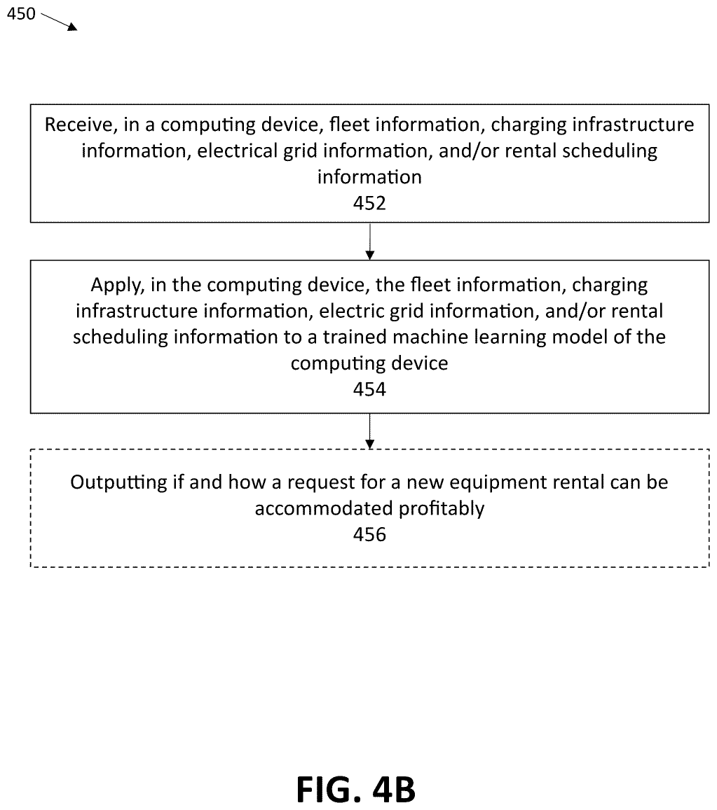

FIG. 4A is one example of a method for training a machine learning model to make decisions relating to the management, charging, scheduling, rental pricing, and optimization of a fleet of all-electric equipment 400. This method may be automatically implemented by a system, such as one or more of the systems in the computing environment 100A, shown in FIG. 1A. At an operation 402, the system may automatically receive information relating to the all-electric fleet, including the fleet information, charging information, utility and power market information, 3^{rd} party vendor or delivery information, and scheduling information described above. Although only a single data set is required to train the model, multiple training cases can improve the model training and increase the accuracy of the machine learning model.

At an operation 404, the system may use the information to train a machine learning model to automatically make decisions or provide an output relating to the management, charging, scheduling, rental pricing, delivery, and optimization of a fleet of all-electric equipment. Multiple training cases comprising the received/obtained information can be input into the machine learning model to further train the model. In some examples, the inputs are used to train a submanifold convolutional neural network. In other embodiments, other convolution techniques can be used, including dense convolutional networks and hybrid approaches. In some examples, the machine learning model is trained to construct a semantic network. In other embodiments, the machine learning model is trained to construct an instance network.

At an optional operation 406, the system can use the trained machine learning model from operation 404 to automatically make decisions or provide an output relating to the management, charging, scheduling, rental pricing, and optimization of a fleet of all-electric equipment. The output can comprise, for example, a purchase order or rental agreement when all the conditions for being able to fulfill the purchase order or rental agreement to satisfy internal requirements such as profitably are met. In some embodiments, the output can trigger the deployment of desired MPUs or other electrical equipment in response to the purchase order or rental agreement. This can include, for example, communicating with rental sites and/or delivery partners, in the form of physical communication such as fax, emails, or automated phone calls or text messages.

According to one example of method 400, the fleet information is selected from the group consisting of battery state of charge of individual equipment, time to empty, physical location, availability of delivery drivers and/or delivery trucks, distance/route information between available equipment and customer delivery address.

According to one example of method 400, the charging infrastructure information is selected from the group consisting of availability of electric charging stations, type of charging stations (including traditional generators and PV infrastructure), distance between individual equipment and charging station, estimated time to charge equipment to desired charge level.

According to one example of method 400, the electric grid information is selected from the group consisting of rates that may be determined based on time-of-use, demand-charge management, spot market prices, existing demand-response programs, supply or demand signals, and other factors that are determined by the utility.

According to one example of method 400, the rental scheduling information is selected from the group consisting of demand/reservations from customers for specific types of equipment or applications.

FIG. 4B is one example of a method of using a trained machine learning model to provide an output relating to the management, charging, scheduling, rental pricing, and optimization of a fleet of all-electric equipment 450. This method may be automatically implemented by a system, such as one or more of the systems in the computing environment 100A, shown in FIG. 1A.

At an operation 452, the system may receive, in a computing device, fleet information, charging infrastructure information, electric grid information, and/or rental scheduling information. At an operation 454, the system may apply, in the computing device, the fleet information, charging infrastructure information, electric grid information, and/or rental scheduling information to a trained machine learning model of the computing device.

At an operation 456, the system may output if and how a request for a new equipment rental can be accommodated profitably. The output can be, for example, communications such as email, texts, faxes, phone calls, or other types of communication instructing or directing an action to be made to fulfill the purchase order or rental agreement. According to certain embodiments, the main communication channel may be handled directly in the cloud-based web application between the fleet manager and the rental customer.

According to one example of method 450, the fleet information is selected from the group consisting of battery state of charge of individual equipment, time to empty, physical location, availability of delivery drivers and/or delivery trucks, distance/route information between available equipment and customer delivery address.

According to one example of method 450, the charging infrastructure information is selected from the group consisting of availability of electric charging stations, type of charging stations, distance between individual equipment and charging station, estimated time to charge equipment to desired charge level.

According to one example of method 450, the electric grid information is selected from the group consisting of rates that may be determined based on time-of-day, supply or demand signals, and other factors that are determined by the utility.

According to one example of method 450, the rental scheduling information is selected from the group consisting of demand/reservations from customers for specific types of equipment or applications.

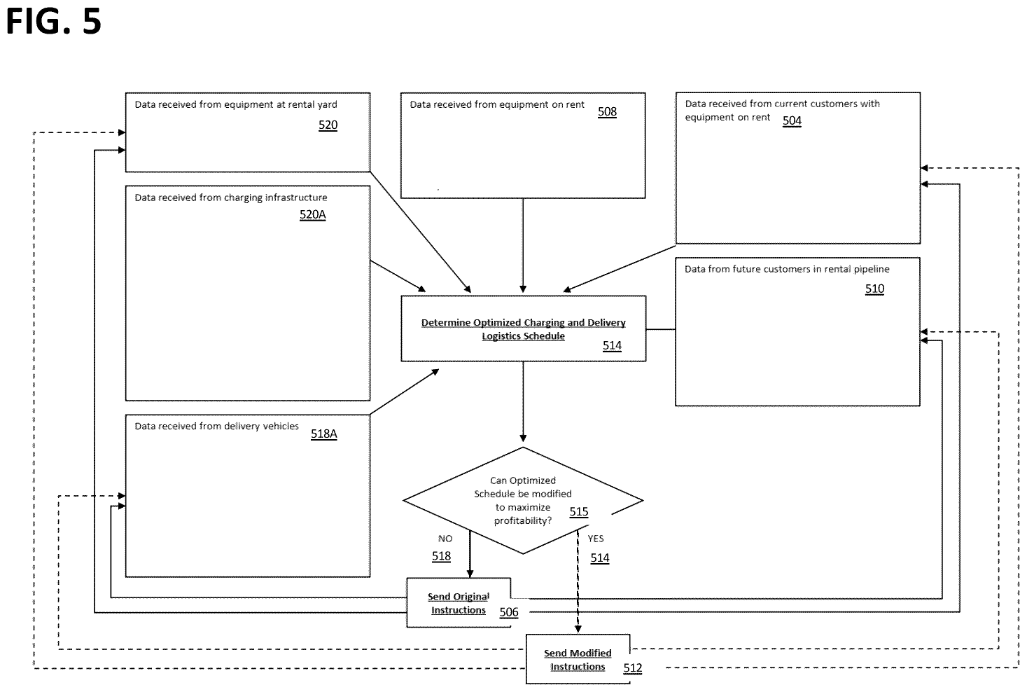

FIG. 5 is an example flowchart with one method for optimizing charging and rental logistics and scheduling. Referring to FIG. 5, data or information relating to all aspects of an all-electric fleet of equipment, including data received from current customers with equipment on rent 504, data received from equipment on rent 508, data from future customers in rental pipeline 510, data received from delivery vehicles 518A, data received from equipment at a rental yard or location 520, and/or data received from a charging infrastructure 520A, can be received/obtained and used to by a central server or cloud computing system 514 (such as any of the computing systems described herein) to determine optimized charging and delivery logistics scheduling outputs based on a request for a rental or purchase contract.

For example, data received from equipment at rental locations 504 and from equipment on rent (e.g., in possession of customers) 510 can include a current optimized charging schedule, the battery states of charge of individual equipment, predicted time until empty battery or no charge, location, expected return date, the remaining kWh of charge required to get to 100% state of charge, and the timing/scheduling of the next customer for a particular piece of equipment, if applicable.

According to certain embodiments, information may also be received or inputted by a customer regarding how the equipment is going to be utilized (e.g., what type of equipment an MPU is going to power). This can provide information on whether the equipment will be a high-use MPU and will likely run out of charge faster, such as for power cranes and industrial equipment, or whether it will be a low-use MPU such as for a smaller jobsite to charge power tools, saws, lights, etc. Various potential customers with different energy needs may include small-scale and large-scale construction, movie sets/studios, disaster relief sites, hospitals, backup power for homes and businesses, etc. The amount of expected use and size of the expected load on the MPU may determine how long the system will estimate it will take for the MPU energy/charge to be used up. This data may assist in determining how many MPUs are needed and in scheduling when replacement units need to be swapped.

Data/information can also be received from the charging infrastructure and related costs and schedules 520A, including utility billing schedules including current billing period demand charge pricing schedules and current demand charge established in a given period, off-site electricity costs, charging related costs (including electricity cost data and time of day), availability of electronic charging stations by type, demand response signals from utility, wholesale capacity commitments (e.g., the amount of generation and other requirements to fulfill ahead of time or as part of real-time contracts), and other utility commitments (ancillary services such as frequency regulation, etc.).

Data/information can also be received from delivery vehicles or services 518A in instances where the equipment is to be delivered to a customer (instead of the customer picking up the equipment from a retail location). This can include current optimized delivery schedules, including route, timing, drop-off/pick-up locations, optimized off-site charging schedules, current location, state of charge of equipment such as batteries and fuel tank levels of delivery vehicles, proximity/distance to nearest charging stations which may be public, private, or rental company yards, etc.

Data/information can also be received from current customers with rental equipment 504, or alternatively, from future customers in the rental pipeline with equipment scheduled to be delivered 510, including rental dates, location, average load/usage or predicted load/usage from site, customer instructions regarding time/dates for swapping/recharging/pickup (which may include or be limited to weekends, evenings, etc.).

All this information can be used by central server or computing system 515, including computing systems with a trained machine learning model, to determine if the request can be optimized or modified to maximize profitability (or any other internally defined requirement). If the charging and delivery logistics schedule can be optimized or modified, at step 514, then the modified instructions 512 can be output from the system to one or more appropriate computing systems. If there is no optimization or modification to be made to the original instructions or request, then at step 518 the original instructions can be output or sent to the appropriate computing system. In some examples, the output can be used to determine whether or not the rental company can accommodate a new customer or a requested rental. For example, if the machine learning model determines that the rental company doesn't have the capacity to accommodate a rental request, or alternatively cannot efficiently or profitably accommodate a rental request, then the machine learning model can decline a rental request and send modified instructions to notify the potential client. According to certain embodiments, the machine learning model may suggest or output modifications or modified instructions 512 in response to one or more of the rental duration, number of units, or model of units to be rented instead of declining a rental request or customer.

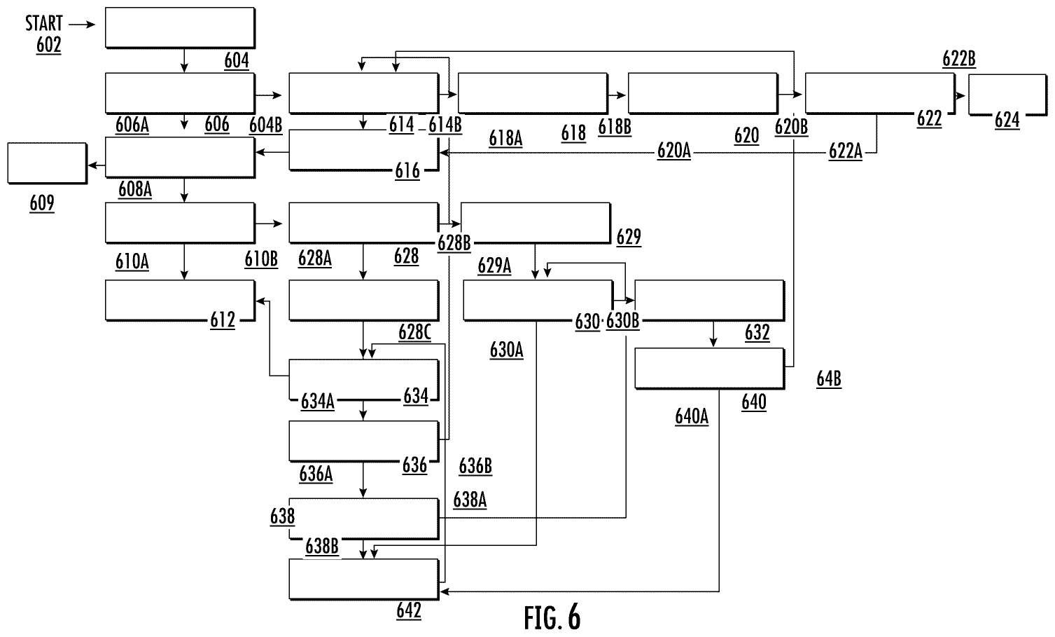

FIG. 6 is a logic flowchart for a new customer request for rental equipment. This logic flowchart can be implemented in one or more computing systems to determine whether or not an electric equipment rental company can accommodate a rental request, and if so, how to implement the rental in an efficient and profitable manner. The flowchart can begin 602 with a customer request for equipment 604. The system can then determine if the requested equipment is available 606. If the equipment is available 606A, then at 608 it is determined if the customer agrees to the offered price. If yes at 608A, then the system can determine if the equipment is sufficiently charged 610 for the customers stated/predicted use. If yes at 610A, the equipment can be delivered to the customer at 612. If the customer does not agree to the offered price 608B, then the customer is declined at 609. According to certain embodiments, the machine learning model may suggest modifications to one or more of the rental duration, number of units, or model of units to be rented instead of declining a rental request or customer.

If the equipment is not immediately available at 604B, the system can determine if the equipment is available for pickup from a current customer at 614 (e.g., the current customer is done with the equipment or doesn't need it anymore). If so at 614A, the price can be optionally modified at 616, and the other equipment can be offered to the customer, and it may be determined whether the customer agrees to the offered price at 608. If equipment is not available for pickup at 614B, the system can also search for additional equipment at other locations 618, can search for other rental date ranges in which the equipment is available 620, or can search for alternative equipment that may meet the customer's needs at 622. If there is alternative equipment that may meet the customer's needs at 622A, or if the customer's dates are flexible at 620A, or if equipment can be delivered from another location at 618A, then the price maybe be modified 616, and the alternative equipment may be offered to the customer. It may then be determined whether the customer agrees to the offered price 608. If after determining that the equipment cannot be delivered from another location at 618B, and that the customer's dates are not flexible at 620B, and further that no equipment is available that meets the customer's needs at 622B, the customer can be declined at 624.

If the equipment is available but is not sufficiently charged at 610, the system can determine at 610B if the equipment can be charged using the least expensive charging queue and delivered on time 628. If so at 628A, the equipment may begin charging using the least expensive charging queue 628C. If the least expensive charging queue is not available or will not result in the equipment being delivered on time 628B, the system can make a determination as to whether a least expensive charging queue can be modified to accommodate the customer 629. If so at 629A, the system may determine if a more expensive charging queue results in acceptable economics/profitability for the rental 630. If a more expensive charging queue does not result in acceptable economics/profitability for the rental at 630B, the rate can be adjusted and offered to the customer at 632. It can then be determined if the customer accepts the new rate at 640. If so at 640A, then continue charging the equipment using the original charging queue 642. If the customer does not accept the new rate at 640B, then it can be determined whether the equipment is available for pickup from another existing customer 614.

The system can also accommodate for new customer requests 634 while the fleet is being charged/managed. If the charging queue can accommodate at 636 all customers, and the charging queue is acceptable from an economics perspective (i.e. a determination is made regarding whether the least expensive charging queue needs to be modified to accommodate customers 638), and it is determined that the least expensive charging queue does not need to be modified at 638B, then the equipment can be charged according to the original queue 642. If the charging queue cannot accommodate all customers, however, then it will be determined whether the equipment is available for pickup from another existing customer 614. If the charging queue can accommodate all customers but the least expensive charging queue does need to be modified to accommodate customers, then it can be determined if the more expensive charging queue results in acceptable economics 630.

According to various embodiments, various user interfaces/portals may be available to different users of the system, including small and large MPU rental customers/businesses, MPU owners, and fleet and operations managers. According to various embodiments, customers and owners may use a rental interface/portal to make and manage reservations, remotely monitor MPUs including location and state of charge, to obtain reservation historical data, and to obtain reservation reports. Fleet and operations managers may use a fleet monitoring interface/portal to perform fleet monitoring (for example via real-time telemetry data). Fleet and operations managers as well as large customers may use a fleet management interface/portal to confirm and manage reservations and perform diagnostics, as assign MPUs to reservations, and remove MPUs or schedule downtime for MPU (to perform maintenance, diagnostics and any work needed on the MPU). According to certain embodiments, such functions of the fleet management interface/portal may be automated, with or without the option of a manual override. Automated functions may also include automatically pulling MPU candidates for assignment to a reservation, which may be based on different MPU models, available MPUs, proximity to a service area or customer location, transport time, and charging time. In some examples, the various user interfaces/portals may be accessed through a single app.

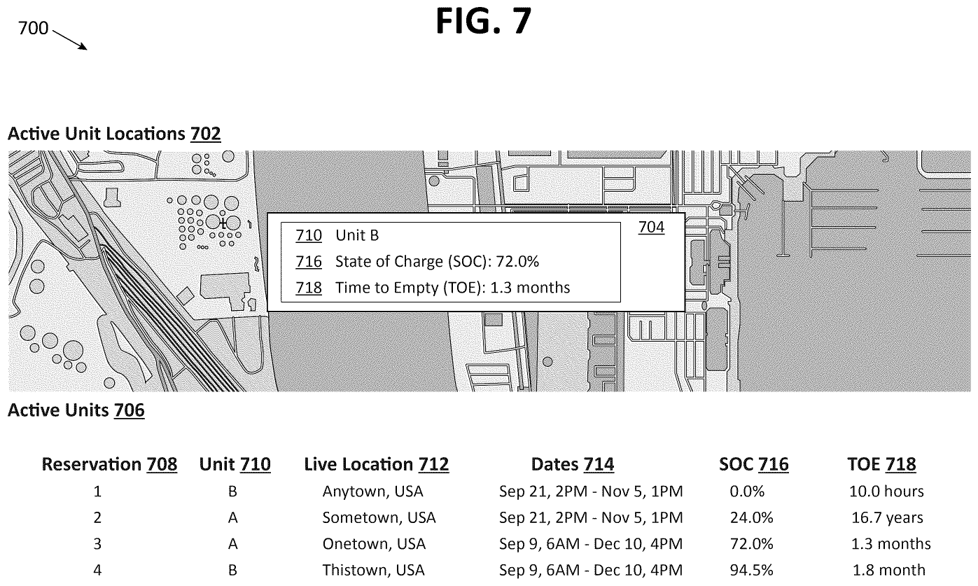

FIG. 7 illustrates a visual reservation summary 700 of a fleet of active mobile power units. The visual reservation summary can be implemented into a computing environment or a display, such as computer readable medium 108 or display 107 of FIG. 1A, or on any other display described herein such as the display of a MPU and/or displays on personal computing devices of customers or fleet managers accessing a web application. Reservation summary 700 may be part of a rental interface/portal or fleet management interface/portal and include a map of active unit locations 702 (which may include coordinates of the MPU location), with unit-specific information 704. Data is displayed for reservation numbers 708 corresponding to units 710, their live locations 712, reservation dates 714 (the time frame of when the MPU is scheduled to be in use), state of charge (SOC) 716 of the units showing for example a current percentage of charge for a unit, and time to empty (TTE) 718 showing when a unit is expected to reach 0% charge and will need to be made inactive, swapped out for another MPU, and/or charged for reuse. TTE 718 information may be used to plan for swapping MPUs.

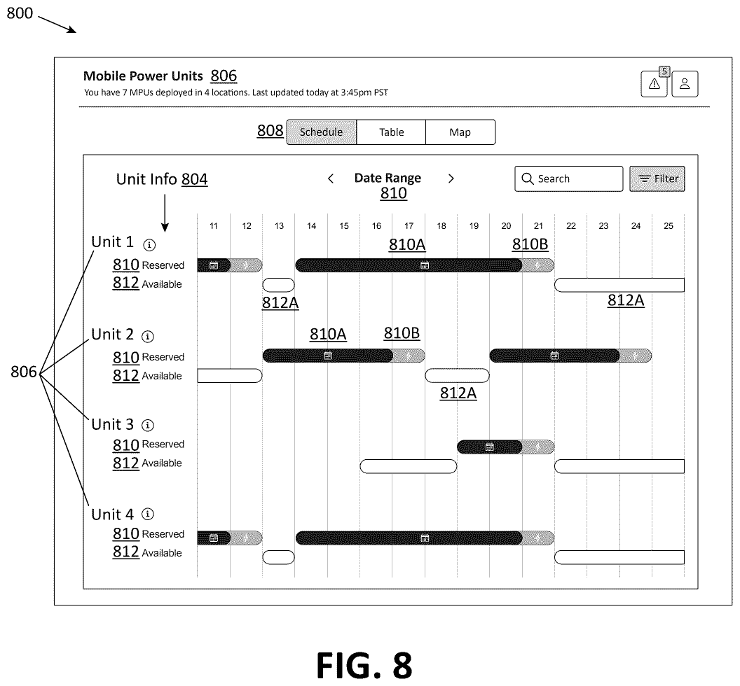

FIG. 8 illustrates a schedule view diagram 800 of mobile power units. According to certain embodiments, schedule view diagram 800 may be part of a fleet management interface/portal implemented into a computing environment or a display, such as computer readable medium 108 or display 107 of FIG. 1A, or any other display described herein including displays coupled to or connected to a web application or platform. As shown here, there is a schedule tab 808 showing various mobile power units 806 and their reservation status 810 or availability status 812 across a given data range 810 represented by horizontal bands 810A-810B and 812A. Reservations status 810 may include a charging time period represented by horizontal band 810B following a reservation period represented by horizontal band 810A. Schedule view diagram of mobile 800 be modified to show variation date ranges 710 from FIG. 7. According to certain embodiments, unit info 804 may be accessed via an icon next to each unit 806.

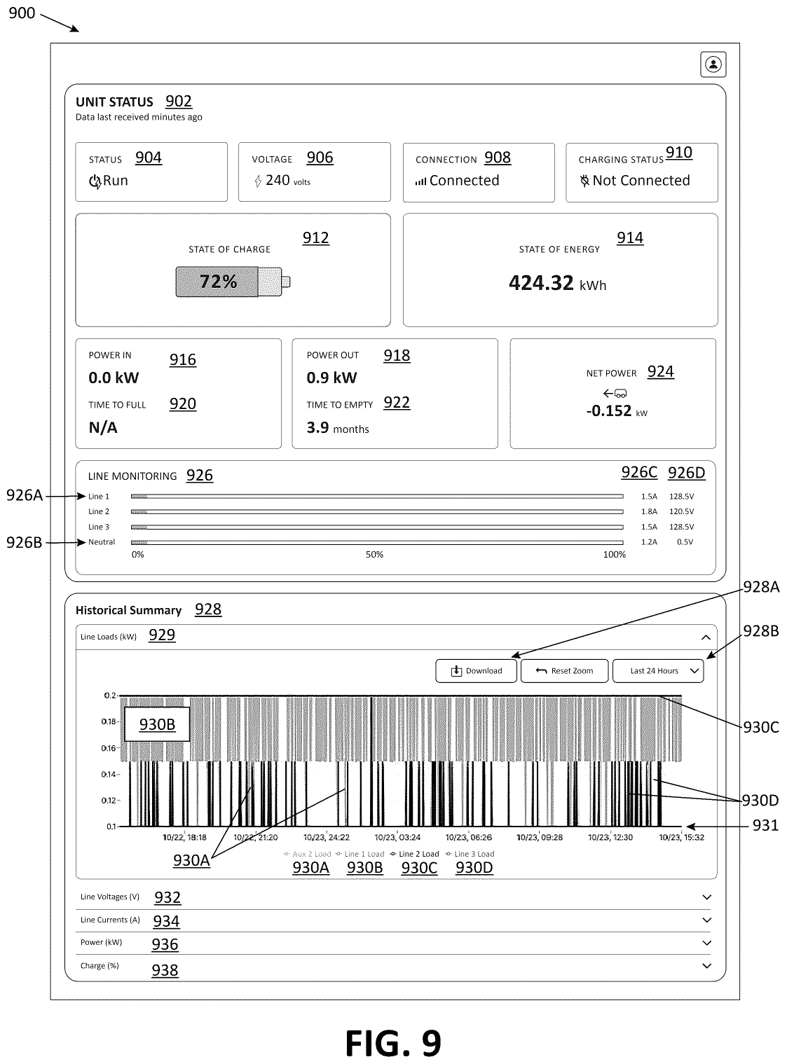

FIG. 9 illustrates an exemplary view of mobile power unit (MPU) information 900. According to certain embodiments, view of MPU information 900 may be part of a rental or fleet monitoring interface/portal and can be implemented into a computing environment or a display, such as computer readable medium 108 or display 107 of FIG. 1A, or on any other display described herein such as the display of a MPU and/or displays on personal computing devices of customers or fleet managers accessing a web application. According to certain embodiments, this view may be accessed via the unit info status 804 icon of FIG. 8. Unit system status 902 is provided for an exemplary mobile power unit including status 904 which may indicate MPU system status or that a status check has been run, voltage output 906 indicating selected voltage output, connections status 908 which may indicate connectivity status of the MPU to a network, charging status 910 which may indicate whether the unit is being charged, state of charge 912 indicated a unit's percentage of charge (percentage amount of available energy), state of energy 914 indicating amount of available energy, which may be expressed in kilowatt-hours (kWh), power in 916 expressing instantaneous power consumed by the MPU (for example, expressed in kilowatts), power out 918 expressing instantaneous power delivered by the MPU (for example, expressed in kilowatts), a time to full 920 representing the time to reach maximum charge or the time it will take to have a full charge when charging, a time to empty 922 representing a time it will take to be fully discharged when serving load, and net power 924 (the difference between power in 916 and power out 918) which may be expressed in kilowatts. Various lines on the mobile power unit such as Line 1 926A and neutral line 926B may be monitored in real-time 926 to display available output power, current 926C and voltage 926D levels.

A historical summary view 928 of line loads (expressed in kilowatts) 929 may also be shown illustrating data for various lines loads 929 displaying output power as a function of time per line, across a date and time range 931, which may be for the last 24 hours 928B or for a customized time range to display historical data. Line loads 929 may include auxiliary load 930A, line 1 load 930B, line 2 load 930C, and line 3 load 930D. Further data may also be provided for line voltages 932 displaying voltage as a function of time per line (which may be expressed as volts), line current 934 displaying current as a function of time per line (which may be expressed in amperes), power 936 displaying total output power as a function of time (which may be expressed in kilowatts), and percentage of charge 938 displaying state of charge as a function of time. Other parameters that may be displayed may include available energy or state of energy as a function of time (expressed in kilowatt-hours) and max pack temp or maximum temperature of the pack, which may be expressed in degrees Celsius. According to certain embodiments, telemetry data from historical summary view 928 may also be downloaded 928A, for example in JSON and CSV formats.

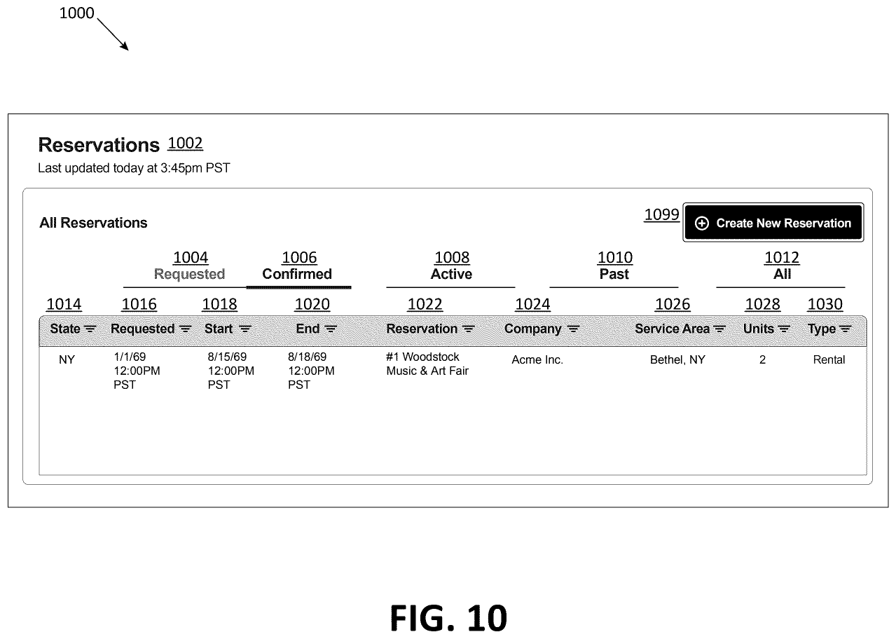

FIG. 10 illustrates a reservation management view 1000 for various customer reservations and may be part of a rental or fleet monitoring interface/portal and can be implemented into a computing environment or a display, such as computer readable medium 108 or display 107 of FIG. 1A, or on any other display described herein such as the display of a MPU and/or displays on personal computing devices of customers or fleet managers accessing a web application. Reservation management view 1000 may be part of a rental or fleet management interface/portal and used by various users including rental customers, MPU owners, and fleet managers to view reservations 1002. Reservation management view 1000 may show different reservation categories including requested reservations 1004, confirmed reservations 1006, active reservations 1008, past reservations 1010, and all reservations 1012. Information on reservations may also be viewed including state 1014, time requested 1016, reservation start time 1018, reservation end time 1020, reservation number and description 1022, the company that the reservation is for 1024, service area 1026, mobile power unit(s) requested or assigned to the reservation 1028, and reservation type 1030 such as demo, pilot or rental. Users may also have the option to create a new reservation via new reservation icon 1099.

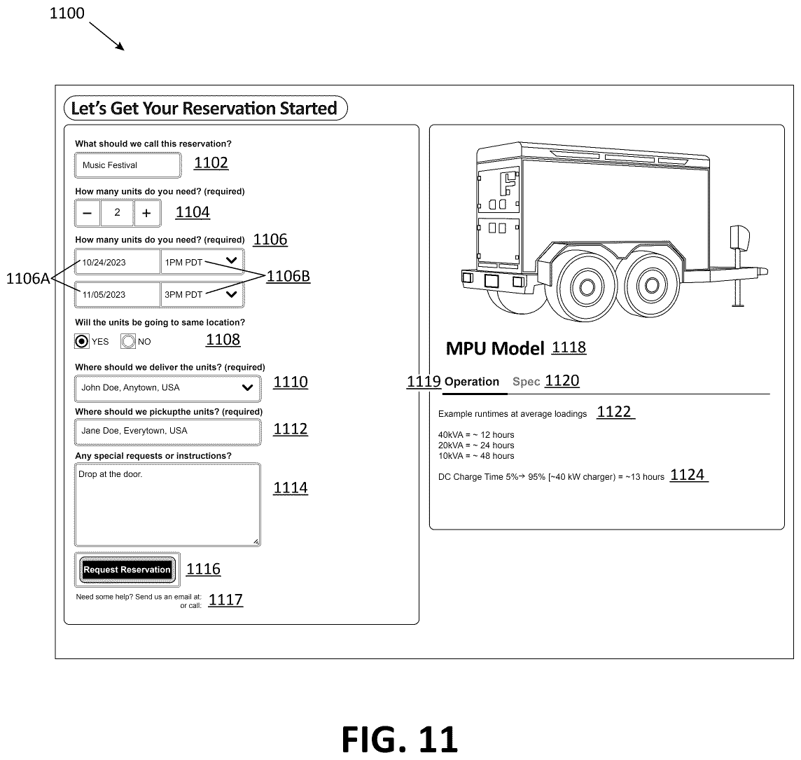

FIG. 11 illustrates a reservation creation interface 1100 for mobile power units. According to certain embodiments, reservation creation interface 1100 may be part of a rental or fleet management interface/portal and customers or other users including managers may create reservations, for example via accessing new reservation icon 1099 from FIG. 10. According to certain embodiments, creating a reservation may include an account registration step. According to certain embodiments, creating a reservation may be automated. Interface 1100 receives various information about a reservation including a reservation name 1102, number of units required 1104, reservation duration 1106 including reservation start and end dates 1106A and reservation start and end times 1106B, the option to designate more than one location for unit delivery 1108, unit delivery location 1110, unit pickup location 1112, and special requests or instructions 1114. Users may then submit a reservation request via an icon 1116. According to certain embodiments, customer service contacts information 1117 may also be provided. Information on mobile power unit (MPU) model 1118 may also be provided including example runtimes at average loading 1122 which may be expressed in kilo-volt-amperes corresponding to a number of hours. DC charge time 1124 may also be viewed, and may be expressed in the number of hours required to go from 5% charge to 95% charge using a 40 kilowatt charger.

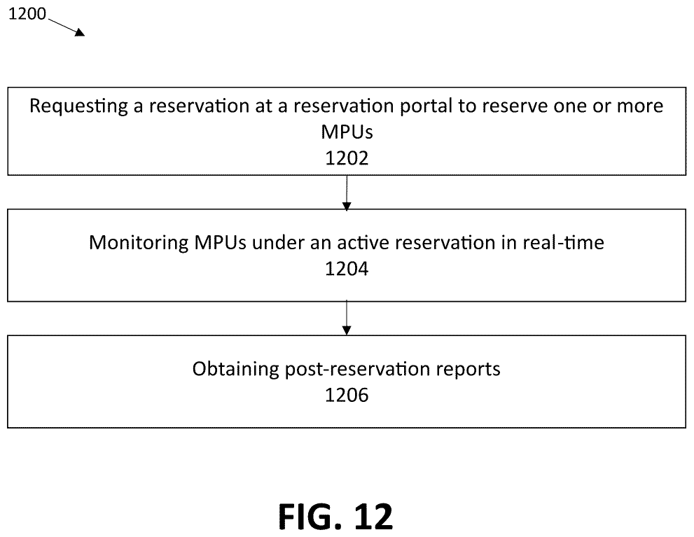

FIG. 12 illustrates a method for requesting a reservation at a rental customer portal 1200. Rental customer portal may include reservation creation interface for mobile power units 1100 discussed in FIG. 11. Method 1200 begins with receiving a request at a reservation portal to reserve one or more MPUs at block 1202. MPUs maybe be monitored under an active reservation in real-time at block 1204 including various MPU data and parameters discussed in FIGS. 8-10. Post-reservation reports may also be obtained or output at block 1206.

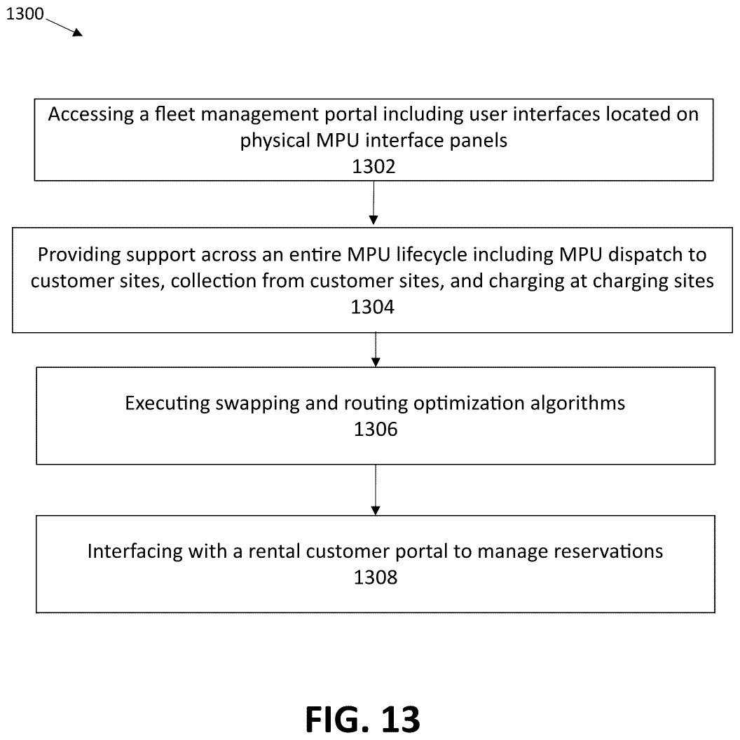

FIG. 13 illustrates a method for fleet management at a fleet management portal 1300. The fleet management portal may be used by fleet managers and field technicians to manage fleets of MPUs. Method 1300 begins at block 1302 with accessing the fleet management portal including accessing information from remote user interfaces (such as information displayed on graphical user interfaces GUIs) at a web application, which may be similar to or correspond with physical digital displays located on MPU interface panels. At block 1304, the fleet management portal may be used to provide support across an entire MPU lifecycle including viewing MPU reservations and MPU fleet monitoring including MPU locations on a map, MPU dispatch to customer sites, collection of MPUs from customer sites, and charging of MPUs at charging sites. Other management options for the MPU lifecycle via the fleet management portal may include schedules including assigning MPUs to reservations, monitoring, charging, diagnostics, repairs, and reporting. Optimization algorithms, such as those discussed in FIGS. 5-6 for optimizing charge, swapping MPUs, rental price, and MPU routing/logistics and delivery scheduling may also be executed, as shown at block 1306. According to certain embodiment, fleet management portal may interface with rental customer portal discussed in FIGS. 10-12 to manage reservations, as shown at block 1308.

According to certain embodiments, when equipment such as MPUs are swapped out, for example because of low or no battery state of charge, the equipment being swapped out may not be charged immediately or at all. This may occur for example, when an MPU is damaged or no longer usable and thus may not need to be charged, or when an MPU will be put into storage or repaired, and a full charge or certain level of charge is not required.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A method of training a machine learning model provide an output relating to the management of a fleet of all-electric equipment, the method comprising the steps of:
receiving, in a computing device, fleet information from one or more all-electric mobile power units (MPUs) of an all-electric fleet;
receiving, in the computing device, charging infrastructure information from one or more charging locations or first computing systems associated with the one or more charging locations;
receiving, in the computing device, electric grid information from one or more utility providers or second computing systems associated with the one or more utility providers;
receiving, in the computing device, rental scheduling information including a customer request for rental of one or more all-electric mobile power units of the all-electric fleet; and
applying the fleet information, charging infrastructure information, electric grid information, and/or rental scheduling information to train a machine learning model of the computing device to determine if and how the customer request for a new equipment rental can be accommodated.

2. The method of claim 1, wherein the applying step further comprises training the machine learning model of the computing device to determine if and how a request for new equipment rental can be accommodated profitably.

3. The method of claim 1, wherein the fleet information is selected from the group consisting of battery state of charge of individual equipment, time to empty, physical location, total energy capacity, operating temperature, and ambient temperature.

4. The method of claim 3, wherein the fleet information is sensed or monitored directly by each MPU in the all-electric fleet and transmitted or communicated directly by each MPU to the computing device.

5. The method of claim 1, wherein the charging infrastructure information is selected from the group consisting of availability of electric charging stations, type of charging stations, distance between individual equipment and charging station, and estimated time to charge equipment to desired charge level.

6. The method of claim 1, wherein the electric grid information is selected from the group consisting of electricity rates that may be determined based on time-of-day, supply or demand signals, and other factors that are determined by the utility.

7. The method of claim 1, wherein the rental scheduling information is selected from the group consisting of requests for specific types of equipment, rental duration, number of units, or model of units to be rented, and expected energy demand.

8. A method of providing an output relating to the management of a fleet of all-electric equipment, the method comprising the steps of:
receiving, in a computing device, fleet information from one or more all-electric mobile power units (MPUs) of an all-electric fleet;
receiving, in the computing device, charging infrastructure information from one or more charging locations or first computing systems associated with the one or more charging locations;
receiving, in the computing device, electric grid information from one or more utility providers or second computing systems associated with the one or more utility providers;
receiving, in the computing device, rental scheduling information including a customer request for rental of one or more all-electric mobile power units of the all-electric fleet; and
applying the fleet information, charging infrastructure information, electric grid information, and/or rental scheduling information to a trained machine learning model of the computing device; and
outputting from the trained machine learning model instructions how the customer request for a new equipment rental can be accommodated.

9. The method of claim 8, wherein outputting further comprises outputting from the trained machine learning model instructions how the customer request for a new equipment rental can be accommodated profitably.

10. The method of claim 8, wherein the fleet information is selected from the group consisting of battery state of charge of individual equipment, time to empty, physical location, total energy capacity, operating temperature, and ambient temperature.

11. The method of claim 10, wherein the fleet information is sensed or monitored directly by each MPU in the all-electric fleet and transmitted or communicated directly by each MPU to the computing device.

12. The method of claim 8 wherein the charging infrastructure information is selected from the group consisting of availability of electric charging stations, type of charging stations, distance between individual equipment and charging station, and estimated time to charge equipment to desired charge level.

13. The method of claim 8, wherein the electric grid information is selected from the group consisting of electricity rates that may be determined based on time-of-day, supply or demand signals, and other factors that are determined by the utility.

14. The method of claim 8, wherein the rental scheduling information is selected from the group consisting of requests for specific types of equipment, rental duration, number of units, or model of units to be rented, and expected energy demand.

15. A system, comprising:
one or more all-electric mobile power units (MPUs) having sensors configured to monitor one or more parameters of the MPUs;
an electric distribution grid configured to provide electricity at one or more prices per unit of electricity according to a pricing schedule;
a charging infrastructure comprising one or more physical locations electrically coupled to the electric distribution grid, each physical location having one or more charging stations or charging units configured to charge MPUs and charging infrastructure information related to the one or more charging stations or charging units;
a web or cloud-based scheduling engine configured to receive rental requests from one or more customers for one or more MPUs; and
a central processing server configured to determine if the rental requests can be accommodated profitably based on one or more received parameters of the MPUs, a received pricing schedule from the electric distribution grid, a received a status of the one or more charging stations or charging units from the charging infrastructure, and based on received rental requests from the web or cloud-based scheduling engine, the central processing server being further configured to output instructions relating to the one or more customer requests.

16. The system of claim 14, wherein the one or more parameters of the MPUs corresponds to MPU information displayed on a user interface on an interface panel located on the one or more of the MPUs.

17. The system of claim 14, wherein the one or more parameters of the MPUs is selected from the group consisting of battery state of charge, time to empty, physical location, total energy capacity, operating temperature, and ambient temperature.

18. The system of claim 14, wherein the charging infrastructure information is selected from the group consisting of availability of electric charging stations, type of charging stations, distance between individual equipment and charging station, and estimated time to charge equipment to desired charge level.

19. The system of claim 14, wherein the pricing schedule is selected from the group consisting of electricity rates that may be determined based on time-of-day, supply or demand signals, and other factors that are determined by the utility.

20. The system of claim 14, wherein the customer request can include scheduling information selected from the group consisting of requests for specific types of equipment, rental duration, number of units, or model of units to be rented, and expected energy demand.
